(19) United States
(12) Patent Application Publication
(10) Pub. No.: US 2012/0176092 A1
(43) Pub. Date: Jul. 12, 2012

(54) BATTERY CAPACITY DETECTION DEVICE OF LITHIUM ION RECHARGEABLE BATTERY

(75) Inventors: Hiroki FUJII, Kariya-shi (JP); Naomi Awano, Nagoya (JP); Hisashi Umemoto, Chiryu-shi (JP)

(73) Assignee: DENSO CORPORATION, Kariya-city (JP)

(21) Appl. No.: 13/347,995

(22) Filed: Jan. 11, 2012

(30) Foreign Application Priority Data
Jan. 11, 2011 (JP) 2011-003073

(51) Int. Cl. H02J 7/00; G01N 27/416

(52) U.S. Cl. 320/134; 324/427

(57) ABSTRACT

A device detects a battery capacity of a lithium ion rechargeable battery having at least one inflection point or more within a range of 10% to 90% of the SOC thereof. The inflection point indicates a change of a correlation between a battery voltage and the SOC of the battery. The device fetches a battery capacity corresponding to an inflection point from a capacity table, and sets the fetched battery-capacity as a first battery capacity when an inflection point detection section detects the inflection point. A current integration section integrates a current from the time to detect the inflection point to the time when the battery voltage detected by a voltage detection section reaches a full charging voltage. The integrated current is used as a second battery capacity. The device adds the first and second battery capacities, and uses the added result as a full charging capacity of the battery.

### CROSS-REFERENCE TO RELATED APPLICATION

This application is related to and claims priority from Japanese Patent Application No. 2011-003073 filed on Jan. 11, 2011, the contents of which are hereby incorporated by reference.

### BACKGROUND OF THE INVENTION

1. Field of the Invention

The present invention relates to devices for detecting a full charging capacity of a lithium ion rechargeable battery (or a lithium ion secondary battery) with a high accuracy even if a full battery capacity thereof is decreased after the elapse of time.

2. Description of the Related Art

In general, a full battery capacity of a lithium ion rechargeable battery is decreased according to deterioration of the lithium ion rechargeable battery after the elapse of time. It is necessary to detect a decreased amount of the charging capacity to a full charging capacity at the first time the lithium ion rechargeable battery is used in order to know the time to replace the lithium ion rechargeable battery with a new lithium ion rechargeable battery. In order to detect the decreased amount of the charging capacity of the lithium ion rechargeable battery with high accuracy, it is necessary to detect the full charging capacity of the lithium ion rechargeable battery after the deterioration thereof with a high accuracy. For example, there are two conventional patent documents 1 and 2 which disclose conventional techniques. The conventional patent document 1 is Japanese patent laid open publication No. JP 2009-296699, and the conventional patent document 2 is Japanese patent laid open publication No. JP 2009-129644.

In the conventional technique disclosed in the patent document 1, the process of charging the rechargeable battery is temporarily stopped, a voltage slope of the rechargeable battery is detected, where the voltage slope indicates a voltage drop rate per unit time on the basis of the terminal voltage of the rechargeable battery which is detected after the stop of the charging process. Because the voltage drop rate of the terminal voltage of the rechargeable battery has a steep slope when the process of charging the rechargeable battery is stopped, it can be said that there is a strong relationship between the voltage drop rate and a state of charge (SOC). This fact makes it possible to detect the SOC of the rechargeable battery on the basis of the relationship between the voltage drop rate and the SOC.

On the other hand, because the conventional technique disclosed in the patent document 2 uses a rechargeable battery (or a rechargeable battery) having a positive electrode made of material of olivine type having a small SOC dependency of an internal resistance, it is possible to provide the battery having stable IV (current-voltage) characteristics within a wide SOC range. When a voltage change rate of this rechargeable battery exceeds a predetermined value on a characteristic curve which shows the relationship between the terminal voltage (V) and the SOC (%) of the rechargeable battery, SOC estimation is executed by using integrated current value within a flat voltage range which is not more than the threshold value, and the SOC estimation is executed by using a voltage when the voltage change rate of the rechargeable battery exceeds the threshold value.

However, the conventional technique disclosed in the conventional patent document 1 needs to stop the process of charging and discharging the rechargeable battery when the SOC of the rechargeable battery is detected. This decreases the efficiency to use a load device which consumes the electric power of the rechargeable battery.

In the conventional technique disclosed by the conventional technique 2, there is a probability of decreasing the detection accuracy to detect the SOC of the rechargeable battery because the SOC of the rechargeable battery is estimated on the basis of the integrated current value within the range of 15% to 95% of the SOC which has a flat voltage range below the threshold voltage. It is therefore necessary to execute a SOC compensation under a condition close to the full charged condition or the full discharged condition of the rechargeable battery other than the range of 15% to 95% of the SOC. However, it takes a long period of time to make the full discharged condition or the full charged condition of the rechargeable battery. Still further, there is a probability of using the battery within the range of 15% to 95% of the SOC in order to make the full discharged condition or the full charged condition of the rechargeable battery. In this case, it is difficult to detect the SOC of the rechargeable battery with a high accuracy. This causes a problem of not detecting the full charging capacity of the rechargeable battery with a high accuracy after deterioration of the full battery capacity of the rechargeable battery after the elapsed of time.

### SUMMARY

It is therefore desired to provide a battery capacity detection device for detecting a full battery capacity of a lithium ion rechargeable battery (or a lithium ion secondary battery) with a high accuracy after deterioration of the full battery capacity of the lithium ion rechargeable battery in the elapse of time without decreasing the efficiency of a load device which uses the lithium ion rechargeable battery.

An exemplary embodiment provides a battery capacity detection device which detects a battery capacity of a lithium ion rechargeable battery. The lithium ion rechargeable battery has inflection points. There are at least two inflection points. Each inflection point indicates a change of a correlation between a battery voltage and a state of charge (SOC) as a remaining battery capacity of the lithium ion rechargeable battery. In particular, the change of the correlation is within a range of 10% to 90% of the SOC. In the battery capacity detection device, an inflection point detection section detects, as an inflection point, a point at which the voltage change rate of the lithium ion rechargeable battery detected by a voltage detection section exceeds a predetermined threshold value. A current integral section integrates a charging and discharging current of the lithium ion rechargeable battery as an integrated current value. A battery capacity detection section fetches, as a first battery capacity, the battery capacity corresponding to the detected inflection point from a capacity table when the inflection point detection section detects the inflection point. In the capacity table in the battery capacity detection section, the inflection point and the battery capacity are related in one-to one correspondence. The battery capacity detection section sets, as a second battery capacity, the integrated current value integrated by the current integration section from the time when the inflection point detection section detects the inflection point to a time when the battery voltage detected by the voltage detection section reaches a full charging voltage of the lithium ion rechargeable battery. The battery capacity detection section calculates a full charging capacity of the lithium ion rechargeable battery.

Because the battery capacity detection device having the above structure fetches from the above capacity table the battery capacity of the lithium ion rechargeable battery when the inflection point detection section detects the inflection point, and uses the fetched battery capacity as the first battery capacity, this first battery capacity corresponds to a correct charging capacity of the lithium ion rechargeable battery measured from zero to the charge at the inflection point of the lithium ion rechargeable battery with high accuracy. Still further, because the battery capacity detection device uses, as the second battery capacity, the integrated current value from the time when the inflection point is detected to the time when the voltage of the lithium ion rechargeable battery becomes the full charging voltage, the obtained second battery capacity corresponds to the charging capacity from the time when the second inflection point is detected to the time when the voltage of the lithium ion rechargeable battery reaches the full charging voltage with high accuracy. The total sum of the first battery capacity and the second battery capacity becomes the correct full charging capacity of the lithium ion rechargeable battery. Because the device having the above structure avoids the lithium ion rechargeable battery from being temporarily stopped in order to obtain a current full charging capacity of the lithium ion rechargeable battery, it is possible to enhance the usability of various load devices using the lithium ion rechargeable battery. Still further, even if the full charging capacity of the lithium ion rechargeable battery is deteriorated after the elapse of time, the battery capacity detection device can detect the full charging capacity of the lithium ion rechargeable battery with a high accuracy. In other words, it is possible for the battery capacity detection device to detect the full charging capacity of the lithium ion rechargeable battery with high accuracy even if the lithium ion rechargeable battery is deteriorated after the elapse of time.

### BRIEF DESCRIPTION OF THE DRAWINGS

A preferred, non-limiting embodiment of the present invention will be described by way of example with reference to the accompanying drawings, in which:

FIG. 1 is a block diagram showing a structure of a battery system using a battery capacity detection device capable of detecting a battery capacity of a lithium ion rechargeable battery according to an exemplary embodiment of the present invention;

FIG. 2 is a view showing a terminal open voltage curve VL corresponding to a battery voltage V against a SOC (%) of the lithium ion rechargeable battery shown in FIG. 1;

FIG. 3 is a view showing one example of a relationship between a voltage change rate dV/dt and a battery capacity Ah of the lithium ion rechargeable battery, in particular, shows one example of a range of a first battery capacity Ih1 and a range of a second battery capacity Ih2;

FIG. 4 is a view showing another example of a relationship between a voltage change rate dV/dt and a battery capacity Ah of the lithium ion rechargeable battery, in particular shows another example of a range of the first battery capacity Ih1 and a range of the second battery capacity Ih2; and

FIG. 5 is a flow chart which explains a process of detecting a full charging capacity of the lithium ion rechargeable battery.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Exemplary Embodiment

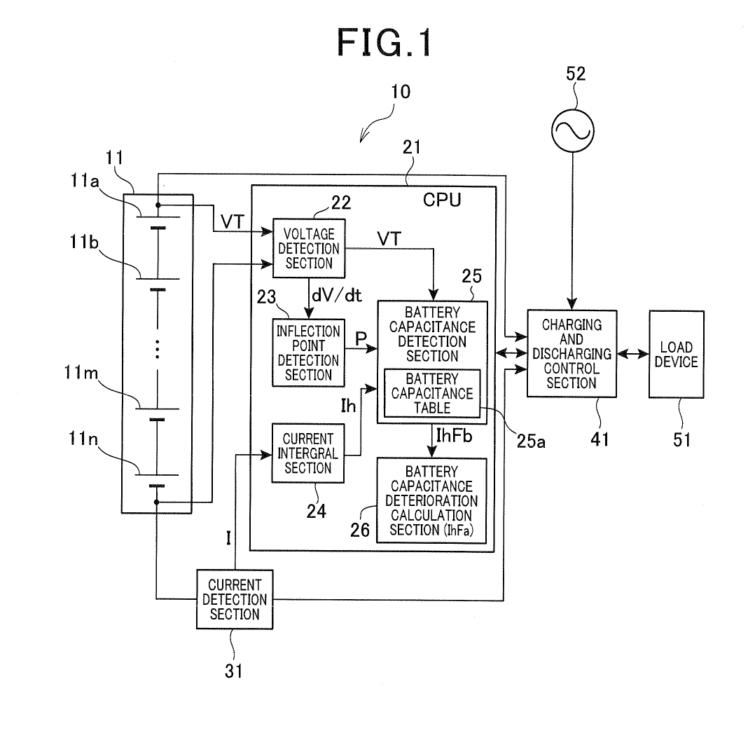

A description will be given of a battery capacity detection device of detecting a battery capacity of a lithium ion rechargeable battery (or a lithium ion secondary battery) according to an exemplary embodiment of the present invention with reference to FIG. 1 to FIG. 5.

FIG. 1 is a block diagram showing a structure of the battery system 10 equipped with the battery capacity detection device. The battery capacity detection device detects a battery capacity of a lithium ion rechargeable battery 11 according to the exemplary embodiment.

The battery system 10 is comprised of a plurality of cells 11a, 11b, . . . , 11m, and 11n connected in series (forming a lithium ion rechargeable battery), a central processing unit (CPU) 21, a current detection section 31 and a charging and discharging control section 41. The plural cells 11a, 11b, . . . , 11m, and 11n are connected in series and form the lithium ion rechargeable battery as an assembled battery. The CPU 21 acts as the battery capacity detection device capable of detecting the battery capacity of the lithium ion rechargeable battery 11. The current detection section 31 detects a charging current to the lithium ion rechargeable battery 11 or a discharging current from the lithium ion rechargeable battery 11. The charging and discharging control section 41 is connected to the lithium ion rechargeable battery 11 through the current detection section 31. The charging and discharging control section 41 is connected to a load device 51. The charging and discharging control section 41 is a unit which can be detached from a commercial power source 52.

In the exemplary embodiment, the lithium ion rechargeable battery 11 has a positive electrode which contains at least lithium metal phosphate having an olivine structure. Still further, the lithium metal phosphate has a chemical formula LiMPO₄, where M is at least one of Mn, Fe, Co and Ni.

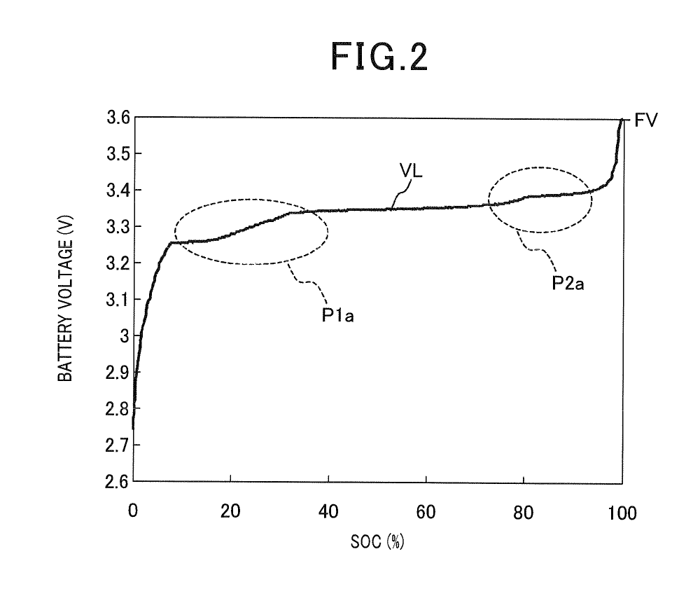

FIG. 2 is a view showing a terminal open voltage curve VL corresponding to a battery voltage V against a SOC (%) of the lithium ion rechargeable battery 11 shown in FIG. 1. The SOC indicates a state of charge of the lithium ion rechargeable battery 11.

As shown in FIG. 2, the characteristic curve (as a terminal voltage discharging curve) which shows the battery voltage (V) against the SOC(%) in the lithium ion rechargeable battery 11 having an olivine structure. In FIG. 2, a vertical line indicates the battery voltage (V) between both electrode terminals of the lithium ion rechargeable battery 11, and a horizontal line indicates a remaining energy amount (as a remaining capacity) of the lithium ion rechargeable battery 11. The remaining energy amount as the remaining capacity corresponds to a state of charge (SOC) of the lithium ion rechargeable battery 11. As shown by the terminal open voltage curve VL in FIG. 2, when the battery voltage is 3.6 V of the full charging voltage FV, the SOC of the lithium ion rechargeable battery 11 has a full charged state of 100%. In addition, although the slope of the battery voltage V has a smooth curve within a range of 10% to 90% of the SOC in the terminal open voltage curve VL, there are inflection points, designated by characters P1a and P2a in FIG. 2, having a large slope angle within the range of 10% to 90% of the SOC.

As shown in FIG. 2, the lithium ion rechargeable battery 11 having an olivine structure according to the exemplary embodiment has two inflection ranges. However, the scope of the present invention is not limited by the exemplary embodiment. For example, it is acceptable to use a lithium ion rechargeable battery without having any olivine structure if it has at least one inflection range or more inflection ranges within the range of 10% to 90% of the SOC.

The load device 51 is a device to consume electric power, such as an in-vehicle motor, an in vehicle hybrid motor, an air conditioning system, a commercial air conditioning system and a power device. The load device 51 executes a predetermined operation on receiving electric power supplied from the lithium ion rechargeable battery 11.

When receiving a charging and discharging instruction supplied from the CPU 21, the charging and discharging control section 41 instructs the lithium ion rechargeable battery 11 to supply (or discharge) electric power to the load device 51, and instructs the lithium ion rechargeable battery 11 to receive (or charge) electric power supplied from the commercial electric power source 52. The lithium ion rechargeable battery 11 is charged by the electric power supplied from the commercial electric power source. In particular, the lithium ion rechargeable battery 11 is charged with a constant current (a constant current charging). If the load device 51 is a device capable of generating electric power such as an in-vehicle hybrid motor, it is necessary to control the load device 11 to supply electric power to the lithium ion rechargeable battery 11 with a constant current.

The CPU 21 is comprised of a voltage detection section 22, an inflection point detection section 23, a current integral section 24, a battery capacity detection section 25 and a battery capacity deterioration calculation section 26.

The voltage detection section 22 detects a voltage (or a battery voltage) between both electrodes of the lithium ion rechargeable battery 11, and outputs the detected voltage to the battery capacity detection section 25. Further, the voltage detection section 22 calculates a voltage change rate dV/dT as a change rate of the battery voltage Vt per unit time, and outputs the calculation result to the inflection point detection section 23.

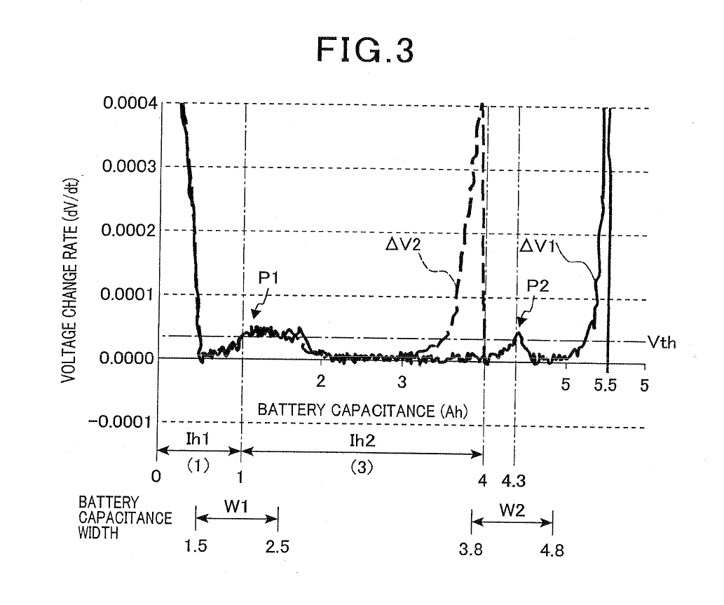

FIG. 3 is a view showing one example of a relationship between a voltage change rate dV/dt, a battery capacity (Ah) of the lithium ion rechargeable battery, a first battery capacity Ih1 and a second battery capacity Ih2. In the exemplary embodiment, when the battery voltage VT is a voltage which traces the terminal open voltage curve VL against the SOC (%) shown in FIG. 2, the voltage change rate dV/dt becomes a curve (as a voltage change rate curve) designated by reference character Δ1 or Δ2 in the relationship with the battery capacity (Ah) of the lithium ion rechargeable battery 11 shown in FIG. 3.

The voltage change rate curve ΔV1 shows the voltage change rate dV/dt at an initial state when the lithium ion rechargeable battery 11 is not adequately used at the first time the lithium ion rechargeable battery is used. The voltage change rate curve ΔV2 shows the voltage change rate dV/dt after a predetermined elapse of time and the lithium ion rechargeable battery 11 is deteriorated.

At the first time the lithium ion rechargeable battery 11 is used, as designated by the terminal open voltage curve VL shown in FIG. 2, the SOC becomes 100% when the full charging voltage FV is 3.6 V (FV=3.6V). As designated by the voltage change rate curve ΔV1 shown in FIG. 3, the lithium ion rechargeable battery 11 reaches its full charging capacity at the battery capacity of 5.5 Ah.

On the other hand, as designated by the voltage change rate curve ΔV2 shown in FIG. 2, the lithium ion rechargeable battery 11 reaches its full charging capacity at the battery capacity of 4.0 Ah after the predetermined elapse of time.

In particular, the full charging capacity of the lithium ion rechargeable battery 11 becomes 4.0 Ah in the voltage change rate curve ΔV2 by the predetermined elapse of time, which is less than the full charging capacity of 5.5 Ah at the first time the lithium ion rechargeable battery 11 is used. However, the voltage change rate curve ΔV2 is approximately equal to the voltage change rate curve ΔV1 during the range near the battery capacity of 3.0 Ah.

The inflection point detection section 23 detects an inflection point on the basis of the voltage change rate dV/dt which is transferred from the voltage detection section 22.

As shown in FIG. 3, the inflection point detection section 23 detects, as the inflection point P1 or P2 at the time when the voltage change rate dV/dt exceeds a predetermined threshold value Vth, the voltage change rate dV/dt designated by each of the voltage change rate curve ΔV1 and the voltage change rate curve ΔV2. The inflection point detection section 23 transfers the detected inflection point P (P1 or P2) to the battery capacity detection section 25. The predetermined threshold value Vth is used in order to detect the point at which the voltage change rate dV/dt is changed at a predetermined slope angle or a predetermined inclined angle by which the sloped angle of the curve is clearly shown when compared with another range. Accordingly, the point which exceeds the threshold value Vth becomes the inflection point P1 or P2. Because the inflection point P1 or P2 exists in the inflection ranges P1a and P2a shown in FIG. 2, it is possible to detect a correlation between the voltage change rate dV/dt and the battery capacity Ah.

The current integral section 24 sequentially integrates the charging current when the lithium ion rechargeable battery 11 is charged, and sequentially subtracts the discharging current from the integrated charging current. That is, the current integral section 24 executes the integration of the charging and discharging current. The current integral section 24 integrates the charging and discharging current I and transfers the current integrated current value Ih to the battery capacity detection section 25.

The battery capacity detection section 25 has a capacity table 25a in which the first inflection point P1 shown in FIG. 3 and the corresponding battery capacity (for example, 1 Ah) are related in one-to one correspondence, and the second inflection point P2 and the corresponding battery capacity (for example, 4.3 Ah) are related in one-to one correspondence. On receiving the information regarding the inflection point P transferred from the inflection point detection section 23, the battery capacity detection section 25 judges that the inflection point P is the first inflection point P1 when the integrated current value Ih supplied from the current integral section 24 is within a predetermined first battery capacity range W1 (for example, within a range of 1.5 Ah to 2.5 Ah) shown in FIG. 3. Further, the battery capacity detection section 25 judges that the inflection point P is the second inflection point P2 when the integrated current value Ih supplied from the current integral section 24 is within a predetermined second battery capacity range W2 (for example, within a range of 3.8 Ah to 4.8 Ah) shown in FIG. 3.

When the judgment result indicates that the inflection point P is the first inflection point P1, the battery capacity detection section 25 refers the capacity table 25a, and stores the battery capacity of 1 Ah which corresponds with the first inflection point P1 as the first battery capacity Ih1 shown in FIG. 3. Further, the battery capacity detection section 25 stores the integrated current value Iha when receiving the inflection point P transferred from the inflection point detection section 23, and obtains the second battery capacity Ih2 (for example, 3 Ah) shown in FIG. 3 by subtracting the integrated current value, which has been stored, from the integrated current value Ihb when the battery voltage VT transferred from the voltage detection section 22 becomes the full charging voltage FV. Further, the battery capacity detection section 25 adds the obtained second battery capacity Ih2 of 3 Ah and the previously stored first battery capacity Ih1 of 1 Ah in order to obtain the full charging capacity IhFb of 4 Ah. The battery capacity detection section 25 outputs the obtained full charging capacity as the current full charging capacity IhFb to the battery capacity deterioration calculation section 26.

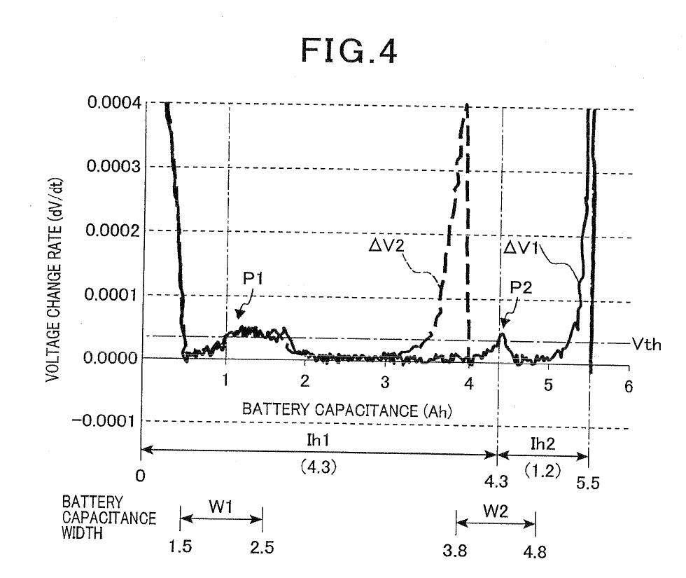

FIG. 4 is a view showing another example of a relationship between the voltage change rate dV/dt, the battery capacity (Ah) of the lithium ion rechargeable battery 11, the first battery capacity Ih1 and the second battery capacity Ih2. On the other hand, when the judgment result indicates that the inflection point P is the second inflection point P2, the battery capacity detection section 25 refers the capacity table 25a, and stores the battery capacity of 4.3 Ah which corresponds with the second inflection point P2 as the first battery capacity Ih1 shown in FIG. 4. Further, the battery capacity detection section 25 stores the integrated current value Iha when receiving the inflection point P transferred from the inflection point detection section 23, and obtains the second battery capacity Ih2 (for example, 1.2 Ah) shown in FIG. 4 by subtracting the integrated current value Iha, which has been stored, from the integrated current value Ihb when the battery voltage VT transferred from the voltage detection section 22 becomes the full charging voltage FV. Further, the battery capacity detection section 25 adds the obtained second battery capacity Ih2 of 1.2 Ah and the previously stored first battery capacity Ih1 of 4.3 Ah in order to obtain the full charging capacity IhFb of 5.5 Ah. The battery capacity detection section 25 outputs the obtained full charging capacity as the current full charging capacity IhFb to the battery capacity deterioration calculation section 26.

Still further, after the detection of the first inflection point P1, the battery capacity detection section 25 overwrites the first battery capacity Ih1, which corresponds to the second inflection point P2, onto the first battery capacity Ih1, which corresponds to the first inflection point P1. This the first inflection point P1 has already been stored when the battery voltage VT does not reach the full charging voltage FV after the judgment of the first inflection point P1 and the battery capacity detection section 25 detects the second inflection point P2 on receiving the following inflection point P transferred from the inflection point detection section 23.

The battery capacity detection section 25 calculates the second battery capacity Ih2, like the previous process, and then obtains the full charging capacity IhFa.

The battery capacity deterioration calculation section 26 stores in advance the full charging capacity IhFa at the first time the lithium ion rechargeable battery 11 is used. The battery capacity deterioration calculation section 26 subtracts the current full charging capacity IhFb (for example, 4 Ah) transferred from the battery capacity detection section 25 from the full charging capacity IhFa (for example, 5.5 Ah) at the first time the lithium ion rechargeable battery 11 is used, which has been stored in advance. The battery capacity deterioration calculation section 26 calculates a percentage of the current full charging capacity against the full charging capacity at the first time the lithium ion rechargeable battery is used. In this case, the battery capacity deterioration calculation section 26 obtains the percentage of 73%. The battery capacity deterioration calculation section 26 then subtracts 73% from 100%, and obtains 23% as the battery capacity after the deterioration of the lithium ion rechargeable battery 11.

When the CPU 21 executes the process of detecting the full charging capacity of the lithium ion rechargeable battery 11, it is acceptable for the CPU 21 to instruct the charging and discharging control section 41 to output a charging and discharging instruction to the load device 51. In this case, when receiving the charging and discharging instruction transferred from the charging and discharging control section 41, the load device 51 consumes the electric power of the lithium ion rechargeable battery 11. After the battery voltage VT detected by the voltage detection section 22 becomes lower than the first inflection point P1, it is acceptable for the CPU 21 to detect the battery capacity of the lithium ion rechargeable battery 11.

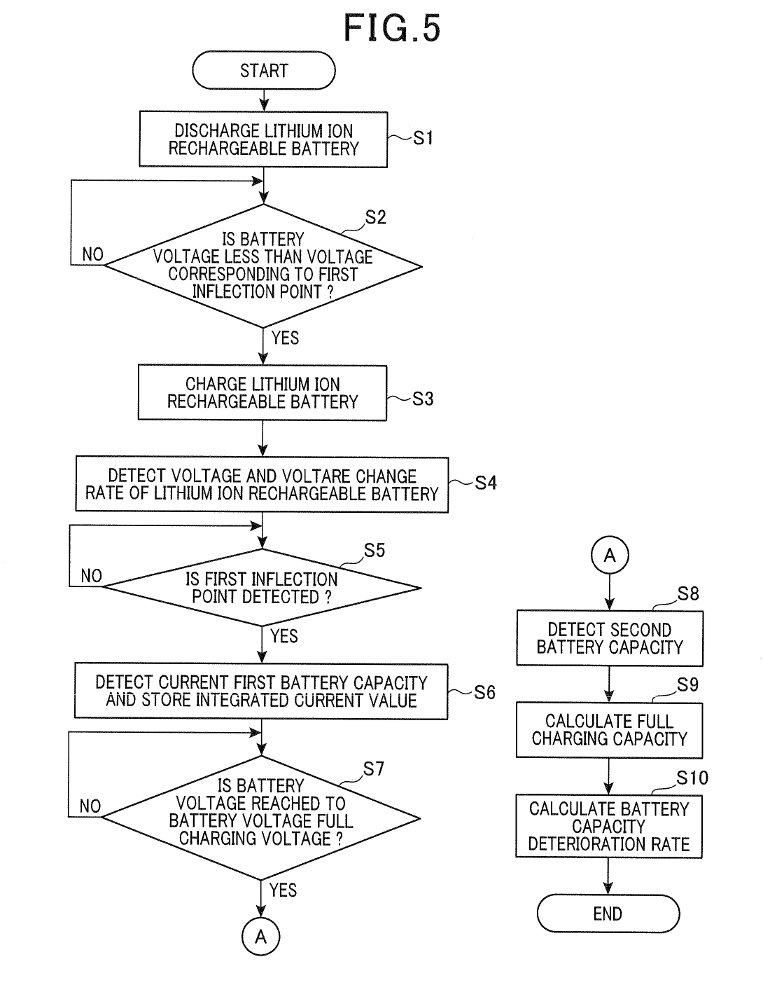

FIG. 5 is a flow chart which explains the process of detecting the full charging capacity of the lithium ion rechargeable battery 11 by the battery system 10.

In the following exemplary embodiment, the lithium ion rechargeable battery 11 has the characteristics of the terminal open voltage curve VL shown in FIG. 2 at the first time the lithium ion rechargeable battery is used. The capacity table 25a of the battery capacity detection section 25 in the CPU 21 stores the data items in which the first inflection point P1 corresponds to the battery capacity of 1 Ah (battery capacity=1 Ah), and the secondary inflection point P2 corresponds to the battery capacity of 4.3 Ah (battery capacity=4.3 Ah). The battery capacity deterioration calculation section 26 stores the data of 5.5 Ah as the full charging capacity IhFa.

Further, the lithium ion rechargeable battery 11 enters a deteriorated condition of the full charging capacity after the elapse of time. On executing the process of detecting the full charging capacity of the lithium ion rechargeable battery 11 under the above condition, an electric power plug of the charging and discharging control section 41 is inserted into a receptacle of the commercial power source 52 during a time range such as night in which the load device 51 does not work.

First, in step S1, the CPU 15 instructs the charging and discharging control section 41 in order to supply the electric power of the lithium ion rechargeable battery 11 to the load device 51 through the charging and discharging control section 41.

In step S2, the CPU 21 detects whether or not the battery voltage VT of the lithium ion rechargeable battery 11, detected by the voltage detection section 22, is less than the voltage corresponding to the first inflection point P1. When the detection result in step S2 indicates that the battery voltage VT of the lithium ion rechargeable battery 11 is less than the first inflection point P1, the operation flow goes to step S3.

In step S3, the CPU 21 outputs the charging instruction to the charging and discharging control section 41 so that the charging and discharging control section 41 instructs the commercial power source 52 to supply its electric power at a constant current amount to the lithium ion rechargeable battery 11. This makes it possible to charge the electric power to the lithium ion rechargeable battery 11 at a constant current amount.

In step S4, the voltage detection section 22 detects the battery voltage VT between the both terminals of the lithium ion rechargeable battery 11 when the lithium ion rechargeable battery 11 is charged, and detects the voltage change rate dV/dt as the change rate of the battery voltage VT per unit time. The voltage change rate dV/dt is designated by the voltage change rate curve ΔV1, which corresponds to the battery capacity Ah, shown in FIG. 3. The voltage detection section 22 outputs the calculated voltage change rate dV/dt to the inflection point detection section 23. The voltage detection section 22 outputs the detected battery voltage VT to the battery capacity detection section 25.

In step S5, when the inflection point detection section 23 detects the inflection point P at which the voltage change rate dV/dt exceeds the predetermined threshold value Vth, the inflection point detection section 23 outputs the data regarding the detected inflection point P to the battery capacity detection section 25. When receiving the data regarding the detected inflection point P, the battery capacity detection section 25 detects whether or not the received inflection point P is equal to the first inflection point P1. When the integrated current value Ih transferred from the current integral section 24 is within the first battery capacity range W1 having the range of 1.5 Ah to 2.5 Ah, the battery capacity detection section 25 judges the inflection point P is the first inflection point P1. When the detection result indicates that the inflection point P is equal to the first inflection point p1 in step S5, the operation flow goes to step S6.

In step S6, the battery capacity detection section 25 refers the capacity table 25a, and searches and fetches the battery capacitor of 1 Ah corresponding to the first inflection point P1. The battery capacity detection section 25 stores the fetched battery capacitor of 1 Ah as the first battery capacity Ih1. At the same time, the battery capacity detection section 25 stores the integrated current value Iha when the battery capacity detection section 25 receives the inflection point P transferred from the inflection point detection section 23.

Next, in step S7, the battery capacity detection section 25 judges whether or not the battery voltage VT transferred from the voltage detection section 22 becomes the full charging voltage FV. When the detection result at step S7 indicates that the battery voltage VT reaches the full charging voltage FV, the operation flow goes to step S8.

In step S8, the battery capacity detection section 25 subtracts the integrated current value Iha stored in step S6 from the integrated current value Ihb supplied from the current integral section 24 when the battery voltage VT reaches the full charging voltage FV. In step S7, the battery capacity detection section 25 obtains the second battery capacity Ih2 (for example, 3 Ah) of the lithium ion rechargeable battery.

Next, in step S9, the second battery capacity detection section 25 adds the second battery capacity Ih2 of 3 Ah and the first battery capacity Ih1 of 1 Ah, and outputs the addition result, namely, the current full charging capacity IhFb of 4 Ah to the battery capacity deterioration calculation section 26.

In step S10, the battery capacity deterioration calculation section 26 divides the received current full charging capacity IhFb by the full charging capacity (for example, 5.5 Ah) at the first time the lithium ion rechargeable battery is used which has been stored. That is, the battery capacity deterioration calculation section 26 executes the division of 4/5.5 and obtains the divisional result of 0.73. The battery capacity deterioration calculation section 26 converts the divisional result of 0.73 to the percentage of 73%, and subtracts the percentage of 73% from 100%. That is, the battery capacity deterioration calculation section 26 obtains the battery capacity deterioration rate of 27%.

As previously described, it can be said that the lithium ion rechargeable battery 11 used in the exemplary embodiment has at least one inflection point or more during the range of the SOC as the remaining capacity within the range of 10% to 90%, where the inflection point clearly indicates the correlation between the battery voltage and the SOC, and the remaining capacity indicates the residual electric power remained in the lithium ion rechargeable battery 11.

The CPU 21 as the battery capacity detection device to detect the battery capacity of the lithium ion rechargeable battery 11 has the voltage detection section 22, the inflection point detection section 23 and the current integral section 24. The voltage detection section 22 detects the battery voltage VT and the voltage change rate dV/dt of the lithium ion rechargeable battery 11. The inflection point detection section 23 detects the voltage change rate dV/dt, detected by the voltage detection section 22, as the inflection point P when the voltage change rate dV/dt exceeds the predetermined threshold value. The current integral section 24 integrals the charging and discharging current I of the lithium ion rechargeable battery 11 as the integrated current value Ih.

Further, the CPU 21 has the battery capacity detection section 25 equipped with the capacity table 25a. The battery capacity detection section 25 obtains the full charging capacity IhFb of the lithium ion rechargeable battery 11. That is, the inflection point P1 and the battery capacity of the lithium ion rechargeable battery 11 are related in one-to-one correspondence in the capacity table 25a. The battery capacity detection section 25 fetches as the first battery capacity Ih1 the data regarding the battery capacity, which corresponds to the inflection point P1 when the inflection point detection section 23 detects the inflection point P1. The battery capacity detection section 25 determines as the second battery capacity Ih2 the integrated current value Ih1 obtained by the current integral section 24 from the time when the inflection point P1 is detected to the time when the battery voltage VT detected by the voltage detection section 22 reaches the full charging voltage FV. The battery capacity detection section 25 adds the second battery capacity Ih2 and the first battery capacity Ih1 to obtain the full charging capacity IhFb.

This structure of the CPU 21 makes it possible to search the battery capacity of the lithium ion rechargeable battery 11 in the capacity table 25a, when the inflection point detection section 23 detects the inflection point P1. In the capacity table, the inflection point P1 and the battery capacity (for example, 1 Ah) are related in one-to one correspondence at the time. The CPU 21 fetches the battery capacity found in the capacity table 25a and uses the obtained battery capacity as the first battery capacity Ih1. This makes it possible to have the relationship in which the first battery capacity Ih1 corresponds to a charging capacity 1 Ah within the range of zero to the inflection point P with a high accuracy. Further, the CPU 21 uses, as the second battery capacity Ih2, the integrated current value Ih obtained from the time when the inflection point P1 is detected to the time when the battery voltage reaches the full charging voltage. That is, the second battery capacity Ih2 corresponds to the charging capacity with a high accuracy from the time when the inflection point is detected to the time when the battery voltage reaches the full charging voltage. Accordingly, it is possible to obtain the full charging capacity IhFb of the lithium ion rechargeable battery 11 with a high accuracy by adding the first battery capacity Ih1 and the second battery capacity Ih2.

A conventional battery capacity detection device needs to stop the operation of the load device when the full charging capacity of the rechargeable battery is detected.

On the other hand, it is not necessary for the CPU 21 as the battery capacity detection device according to the exemplary embodiment to temporarily stop the charging and discharging operation of the lithium ion rechargeable battery 11 when the full charging capacity IhFb is obtained. This makes it possible to be easy to handle the load device which uses the rechargeable battery 11 such as the lithium ion secondary battery.

Still further, even if the full charging capacity of the rechargeable battery 11 is decreased and deteriorated after the elapsed time, it is possible for the CPU 21 as the battery capacity detection device according to the exemplary embodiment to detect the full charging capacity IhFb with a high accuracy, as previously described in detail. In other words, the battery capacity detection device according to the exemplary embodiment can detect the full charging capacity of the rechargeable battery 11 with high accuracy even if the rechargeable battery 11 has deteriorated with time of use.

In the case in which there are at least two inflection points or more such as the first inflection point P1 and the second inflection point P2 counted from zero side of the battery capacity, and the battery voltage detected by the voltage detection section 22 does not reach to the full charging voltage after the inflection point detection section 23 detects the first inflection point P1, and the inflection point detection section 23 detects the second inflection point P2, the battery capacity detection section 25 searches for the battery capacity corresponding to the second inflection point P2 in the capacity table 25a, and uses the found battery capacity as the first battery capacity Ih1.

This structure of the battery capacity detection device according to the exemplary embodiment makes it possible to temporarily detect the first inflection point P1 and to obtain the battery capacity at the detection time of the first inflection point P1. After this, the battery capacity corresponding to the second inflection point P2 is overwritten onto the first battery capacity Ih1 when the second inflection point P2 is detected during the period in which the battery voltage VT does not reach the full charging voltage. That is, when there is a plurality of inflection points P, the battery capacity corresponding to the second inflection point P2 is used as the first battery capacity Ih1 because the inflection point close to the zero of the battery capacity (the first inflection point P1 side) is temporarily detected, and the second inflection point P2 is detected during the range in which the battery voltage does not reach the full charging voltage when the full charging capacity IhFb is not decreased to the value of less than the inflection point (second inflection point P2) closest to the full charging capacity IhFb at the first time the lithium ion rechargeable battery 11 is used even if the lithium ion rechargeable battery 11 deteriorates. Accordingly, even if there are plural inflection points P, it is possible for the battery capacity detection device according to the exemplary embodiment to detect the full charging capacity IhFb of the rechargeable battery 11 with a high accuracy by using the detected inflection point P.

Still further, the battery capacity detection device according to the exemplary embodiment has the CPU 21 and the charging and discharging control section 41 to execute the discharging of the lithium ion rechargeable battery 11 to the state in which the battery capacity is less than that corresponding to the inflection point P1.

The structure of the battery capacity detection device having the CPU 21 and the charging and discharging control section 41 makes it possible to detect the inflection point P with high accuracy and to detect the correct full charging capacity IhFb because the full charging capacity IhFb is detected after the battery capacity of the lithium ion rechargeable battery 11 is deteriorated with age or decreased to a battery capacity of less than that of the inflection point P.

Still further, the battery capacity detection device has the battery capacity deterioration calculation section 26. The battery capacity deterioration calculation section 26 calculates the deterioration degree of the battery capacity of the lithium ion rechargeable battery 11 on the basis of the division result by dividing the full charging capacity detected by the battery capacity detection section 25 with the full charging capacity at the first time the lithium ion rechargeable battery is used, which has been stored in advance.

The battery capacity deterioration calculation section 26 in the battery capacity detection device divides the current full charging capacity (for example, 4 Ah) detected by the battery capacity detection section 25 by the full charging capacity (for example, 5.5 Ah) at the first time the lithium ion rechargeable battery is used which has been stored in advance. The battery capacity deterioration calculation section 26 calculates a percentage of the current full charging capacity against the full charging capacity at the first time the lithium ion rechargeable battery is used. In this case, the battery capacity deterioration calculation section 26 obtains the percentage of 73%. The battery capacity deterioration calculation section 26 then subtracts 73% from 100%, and obtains 27% as the battery capacity after the deterioration of the lithium ion rechargeable battery 11. Accordingly, it is possible for the battery capacity detection device according to the exemplary embodiment to detect the deterioration degree of the lithium ion rechargeable battery 11 with high accuracy.

In addition, it is possible for the lithium ion rechargeable battery 11 to have a positive electrode which contains at least lithium metal phosphate having an olivine structure. Still further, the lithium metal phosphate has a chemical formula LiMPO₄, where M is at least one of Mn, Fe, Co and Ni. It is possible for the battery capacity detection device to have the same effects and actions even if the lithium ion rechargeable battery 11 is made of the above structure.

### (Other Features and Effects of the Battery Capacity Detection Device for Detecting the Battery Capacity of a Lithium Ion Rechargeable Battery According to the Exemplary Embodiment)

As previously described, the battery capacity detection section fetches the battery capacity which corresponds to the second inflection point from the capacity table. The battery capacity detection section uses the fetched battery capacity as the first battery capacity under the conditions: (1) there are at least two inflection points such as the first inflection point and the second inflection point counted from a zero point of the battery capacity; and (2) the battery voltage detected by the voltage detection section does not reach the full charging voltage after the inflection point detection section detects the first inflection point; and (3) the inflection point detection section detects the second inflection point.

In the battery capacity detection device, although the first inflection point is detected once, the first inflection point is replaced, namely rewritten with the battery capacity corresponding to the second inflection point when the second inflection point is detected during the period after the first inflection point is detected and before the battery voltage reaches the full charging voltage of the lithium ion rechargeable battery.

That is, when there are at least two inflection points and the full charging capacity of the lithium ion rechargeable battery is not decreased to a full charging capacity corresponding to the inflection point close to the zero point of the full charging capacity at the first time the lithium ion rechargeable battery is used even if the battery has deteriorated, because the second inflection point is detected during the period to reach the full charging voltage even if the first inflection point close to the zero point of the battery capacity is detected once, the battery capacity detection device uses the battery capacity corresponding to the second inflection point as the first battery capacity. This makes it possible to correctly detect the full charging capacity of the lithium ion rechargeable battery on the basis of the detected inflection points with a high accuracy even if there are many inflection points.

The battery capacity detection device further has the control section. The control section instructs the lithium ion rechargeable battery to discharge to a voltage of less than a voltage corresponding to the detected inflection point.

In the battery capacity detection device having the above structure, because the inflection point is detected with a high accuracy after the control section instructs the lithium ion rechargeable battery to discharge to the state where the battery capacity of the lithium ion rechargeable battery is shifted toward zero point from the battery capacity corresponding to the inflection point. This makes it possible to detect the inflection point with high accuracy and to detect the correct full charging capacity of the lithium ion rechargeable battery.

The battery capacity detection device further has the battery capacity deterioration calculation section capable of storing a full charging capacity of the lithium ion rechargeable battery at the first time the lithium ion rechargeable battery is used in advance. The battery capacity deterioration calculation section calculates a deterioration degree of the lithium ion rechargeable battery on the basis of a value obtained by dividing the full charging capacity, which is detected by the battery capacity detection section, by the stored full charging capacity.

In the battery capacity detection device having the above structure, the current full charging capacity (for example, 4 Ah), which is detected by the battery capacity detection section, is divided by the full charging capacity (for example, 5.5 Ah) at the first time the lithium ion rechargeable battery is used which is stored in advance. The battery capacity detection device calculates a percentage (=73%) of the full charging capacity against the full charging capacity at the first time the lithium ion rechargeable battery is used as the divisional result (=0.73). The battery capacity detection device further obtains the battery deterioration degree of the battery capacity of 27% by subtracting the subtraction result of 73% from 100%. This makes it possible to obtain the correct deterioration degree of the lithium ion rechargeable battery with a high accuracy.

The battery capacity detection device detects the battery capacity of the lithium ion rechargeable battery having a positive electrode which contains at least lithium metal phosphate having an olivine structure:

This makes it possible for the battery capacity detection device to obtain the same effects and actions previously described even if the lithium ion rechargeable battery has a positive electrode which contains at least lithium metal phosphate having an olivine structure.

In the battery capacity detection device, the lithium metal phosphate used in the positive electrode of the lithium ion rechargeable battery has a chemical formula LiMPO₄, where M is at least one of Mn, Fe, Co and Ni.

This makes it possible for the battery capacity detection device to obtain the same effects and actions previously described even if the positive electrode of the lithium ion rechargeable battery has a chemical formula LiMPO₄, where M is at least of Mn, Fe, Co and Ni.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

1. A battery capacity detection device for detecting a battery capacity of a lithium ion rechargeable battery having at least two inflection points, each inflection point indicating a change of a correlation between a battery voltage and a state of charge (SOC) as a remaining battery capacity of the lithium ion rechargeable battery within a range of 10% to 90% of the SOC, comprising:
a voltage detection section for detecting a battery voltage and a voltage change rate of the lithium ion rechargeable battery;
an inflection point detection section for detecting, as inflection point, a point at which the voltage change rate of the lithium ion rechargeable battery detected by the voltage detection section exceeds a predetermined threshold value;
a current integral section for integrating a charging and discharging current of the lithium ion rechargeable battery as an integrated current value; and
a battery capacity detection section having a capacity table in which the inflection point and the battery capacity are related in one-to one correspondence, and for fetching, as a first battery capacity, the battery capacity corresponding to the detected inflection point from the capacity table when the inflection point detection section detects the inflection point, for setting as a second battery capacity the integrated current value integrated by the current integration section from the time when the inflection point detection section detects the inflection point to a time when the battery voltage detected by the voltage detection section reaches a full charging voltage of the lithium ion rechargeable battery, and for calculating a full charging capacity of the lithium ion rechargeable battery.

2. The battery capacity detection device for detecting the battery capacity of a lithium ion rechargeable battery according to claim 1, wherein when there are at least two inflection points, the first inflection point and the second inflection point counted from a zero point of the battery capacity, the battery voltage detected by the voltage detection section does not reach the full charging voltage after the inflection point detection section detects the first inflection point, and when the inflection point detection section detects the second inflection point, the battery capacity detection section fetches the battery capacity corresponding to the second inflection point from the capacity table, and uses the fetched battery capacity as the first battery capacity.

3. The battery capacity detection device for detecting the battery capacity of a lithium ion rechargeable battery according to claim 1, further comprising a control section for instructing the lithium ion rechargeable battery to discharge to a voltage of less than a voltage at the inflection point.

4. The battery capacity detection device for detecting the battery capacity of a lithium ion rechargeable battery according to claim 2, further comprising a control section for instructing the lithium ion rechargeable battery to discharge to a voltage of less than a voltage at the inflection point.

5. The battery capacity detection device for detecting the battery capacity of a lithium ion rechargeable battery according to claim 1, further comprising a battery capacity deterioration calculation section for storing a full charging capacity of the lithium ion rechargeable battery at the first time the lithium ion rechargeable battery is used in advance, and for calculating a deterioration degree of the lithium ion rechargeable battery on the basis of a value which is obtained by dividing the full charging capacity detected by the battery capacity detection section by the stored full charging capacity.

6. The battery capacity detection device for detecting the battery capacity of a lithium ion rechargeable battery according to claim 2, further comprising a battery capacity deterioration calculation section for storing a full charging capacity of the lithium ion rechargeable battery at the first time the lithium ion rechargeable battery is used in advance, and for calculating a deterioration degree of the lithium ion rechargeable battery on the basis of a value which is obtained by dividing the full charging capacity detected by the battery capacity detection section by the stored full charging capacity.

7. The battery capacity detection device for detecting the battery capacity of a lithium ion rechargeable battery according to claim 3, further comprising a battery capacity deterioration calculation section for storing a full charging capacity of the lithium ion rechargeable battery at the first time the lithium ion rechargeable battery is used in advance, and for calculating a deterioration degree of the lithium ion rechargeable battery on the basis of a value which is obtained by dividing the full charging capacity detected by the battery capacity detection section by the stored full charging capacity.

8. The battery capacity detection device for detecting the battery capacity of a lithium ion rechargeable battery according to claim 1, wherein the battery capacity detection device detects the battery capacity of the lithium ion rechargeable battery having a positive electrode which contains at least lithium metal phosphate having an olivine structure.

9. The battery capacity detection device for detecting the battery capacity of a lithium ion rechargeable battery according to claim 8, wherein the lithium metal phosphate used in the positive electrode of the lithium ion rechargeable battery has a chemical formula LiMPO₄, where M is at least one of Mn, Fe, Co and Ni.
